(19) United States
(12) Patent Application Publication
(10) Pub. No.: US 2010/0287405 A1
(43) Pub. Date: Nov. 11, 2010

(54) Method and apparatus for internetworking networks

(75) Inventor: Yee Ming Soon, Tokyo (JP)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tellabs Operations, Inc., Naperville, IL (US)

(21) Appl. No.: 12/387,915

(22) Filed: May 8, 2009

(51) Int. Cl. G06F 11/30; G06F 15/16; G06F 15/173; G06F 11/00

(52) U.S. Cl. 714/4; 709/249; 709/224; 714/E11.179; 714/E11.01; 714/E11.012

(57) ABSTRACT

Methods and apparatuses are disclosed for seamlessly combining an access ring aggregation network, e.g., a G.8032 network, and a core network, e.g., a Multi-Protocol Label Switching (MPLS) network. A link status is monitored between an interworking node and at least one peer node in a first network at an interface between the first network and a second network. Connectivity is maintained between the interworking node and the other interworking node(s) via the second network. Communications between the first and second networks are supported via at least one of the interworking nodes. Ring communications are supported among the interworking node, the other interworking node(s), and the peer node(s). End-to-end integration of two disparate networks according to presently disclosed techniques provides network designers and customers with flexibility in designing, operating, and maintaining networks.

### BACKGROUND OF THE INVENTION

Network service providers commonly utilize aggregation and core networks in large scale networks, such as metropolitan area networks (MANs) and wide area networks (WANs). Aggregation networks, often found at the edge of a service provider's network, aggregate traffic for transmission via a core network, which is the central part of the network. Aggregation networks are sometimes referred to as access aggregation networks because they provide customers with access to the service provider's network, including the core network.

Various communications protocols are used in aggregation and core networks. G.8032 is a ring protocol standardized by the Telecommunication Standardization Sector of the International Telecommunication Union (ITU-T) and is a candidate for use in aggregation networks. Multi-Protocol Label Switching (MPLS) is a technology that has gained favor for use in edge and core networks.

### SUMMARY OF THE INVENTION

An embodiment of the invention is a method, or corresponding apparatus, of internetworking. The method includes monitoring a status of a link between an interworking node and at least one peer node in a first network that includes a first plurality of nodes at an interface between the first network and a second network. The second network includes a second plurality of nodes including the interworking node and other interworking node(s). Connectivity is maintained between the interworking node and the other interworking node(s) via the second network. The method further includes supporting communications between the first and second networks via at least one of the interworking nodes and supporting ring communications among the interworking node, the other interworking node(s), and the peer node(s).

Another embodiment of the invention is a method of internetworking at an interworking node. The method includes monitoring a status of a link between the interworking node and at least one peer node in a first network including a first plurality of nodes at an interface between the first network and a second network. The second network includes a second plurality of nodes including the interworking node and at least one other interworking node. Connectivity is maintained between the interworking node and the other interworking node(s) via the second network. The method further includes supporting communications between the first and second networks via at least one of the interworking nodes.

In a corresponding apparatus embodiment, an interworking node has a link status module configured to monitor a status of a link between the interworking node and a peer node in a first network. The interworking node also has a connection status module configured to monitor a connectivity status between the interworking node and another interworking node. The interworking nodes are configured to support interworking activities at an interface between the first network and a second network including the interworking nodes. The interworking node further includes an internetworking information storage unit to store information to enable traffic to flow via the interworking node between the first network and the second network. The interworking node also includes a traffic support module to enable traffic to flow in a ring among the interworking node, the other interworking node, and at least the peer node in the first network.

Another embodiment of the invention is a method, or corresponding apparatus, that includes employing a ring protocol at multiple ring nodes and employing a second protocol different from the ring protocol at an interworking node in a plurality of interworking nodes. The method further includes monitoring a status of a link between the interworking node and a peer node among the ring nodes and a connectivity state with another interworking node. Ring communications are supported among at least the interworking node, the peer node, and the other interworking node.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIGS. 1A-B are network diagrams corresponding to embodiments of the invention, in which FIG. 1A illustrates normal working conditions, and FIG. 1B illustrates a failover condition.

FIG. 2 is a network diagram showing an interconnection between multiple ring networks and a core network in an embodiment of the invention.

FIG. 3 is a network diagram showing an implementation of an embodiment of the invention in a hierarchical Virtual Private LAN Service (VPLS) network.

FIG. 4 is a block diagram of an interworking node in an embodiment of the invention.

FIG. 5 is a flow diagram of a method 500 of internetworking at an interworking node according to an embodiment of the invention.

FIG. 6 is a flow diagram of a method 600 of internetworking at an interworking node according to another embodiment of the invention.

FIG. 7 is a flow diagram of a method 700 of networking according to an embodiment of the invention.

FIG. 8 is a high level network diagram that shows alternative topologies that may be employed according to embodiments of the invention.

### DETAILED DESCRIPTION OF THE INVENTION

A description of example embodiments of the invention follows.

Traditionally, attempts to provide interworking between access ring aggregation networks, such as G.8032, and core networks, such as Multi-Protocol Label Switching (MPLS), have been unsuccessful. Typically, efforts to interconnect access ring aggregation networks and core networks have required keeping the two networks separate and providing a network-to-network interface connecting the two networks. Such a technique is inefficient and does not provide end-to-end protection of network traffic.

Embodiments of the invention provide end-to-end integration with protection for seamlessly combining an access ring aggregation network, such as G.8032, and a core network, such as MPLS. Such an end-to-end integration of two disparate networks provides network designers and customers with flexibility in designing, operating, and maintaining networks. MPLS in the guise of Virtual Private LAN Service (VPLS) provides multipoint bridging capabilities complementing Provider Backbone Bridges (PBB) over G.8032 in a ring configuration. MPLS supports standards-based PBB encapsulation/decapsulation, and PBB/G.8032 switches treat MPLS “interworking” nodes as normal G.8032 ring nodes. MPLS has gained favor for use in edge and core networks.

G.8032 is a ring protocol that provides a mechanism, known as Ring Protection Link or RPL, to prevent looping on a bridged ring. G.8032 also provides for transmission of Ring Automatic Protection Switching (RAPS) messages in the event of a link outage to inform nodes to flush Media Access Control (MAC) forwarding databases in order to relearn MAC addresses at Layer 2 of the Open Systems Interconnection (OSI) networking stack.

In an MPLS network, routers do not need to consult Internet Protocol (IP) routing tables, which may impose memory limitations, to determine where to forward incoming traffic. Rather, MPLS establishes fixed paths known as label-switched paths (LSPs) from one end of the network to another. Routers in the MPLS network check a label and destination associated with the packet and send the packet to the next router on the fixed path (including the present router) corresponding to the label.

MPLS may be used to implement Virtual Private LAN Service (VPLS), which is a Layer 2 service that emulates LAN service across a large region such as a WAN or a MAN. MPLS enables construction of label switched paths (LSPs), and VPLS makes it possible to interconnect LAN segments over a packet switched network using LSPs and makes the remote LAN segments behave as a single LAN. A VPLS includes Virtual Switching Instances (VSIs), which serve as nodes, and pseudowire (PW) tunnels, which serve as edges. Ethernet packets are forwarded by a VSI to the appropriate PW tunnel for transport across the VPLS network. PBB framing is added on customer frames sent on PW tunnels towards the MPLS core, increasing MAC scalability within the VPLs network towards the core.

Prior to embodiments illustrating the present invention, the networking industry used various Ethernet Ring Protection mechanisms, either standards-based or proprietary, which lacked proper integration into MPLS networks. Traditional 802.1ah PBB networks lack granularity control of user traffic at core and transit nodes. Embodiments of the invention provide granular control over end user traffic quality of service (QoS), bandwidth, and forwarding policies by re-surfacing customer MAC addresses at MPLS networks. Traditional IEEE 802.1ad (Provider Bridge) networks lack scalability protection against an increase in customer MAC addresses; embodiments of the invention address this problem by hiding customer MAC addresses in a G.8032 domain and providing solutions for re-learning MAC addresses in case of path switchovers. Thus, embodiments of the invention address several deficiencies of the prior art, as will be shown below with reference to the figures.

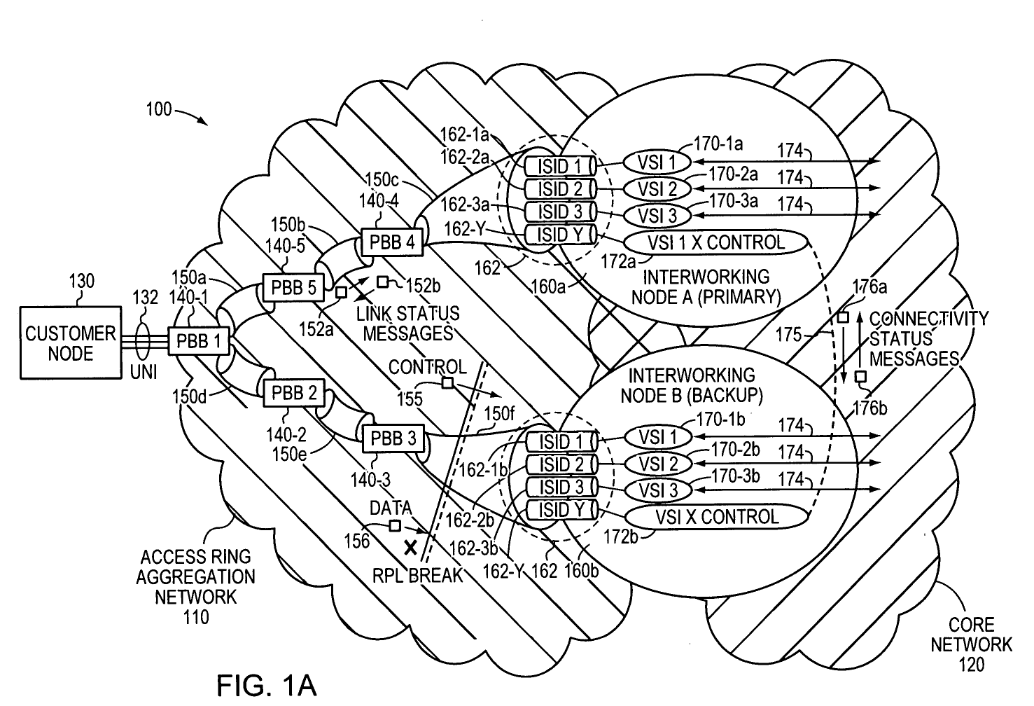

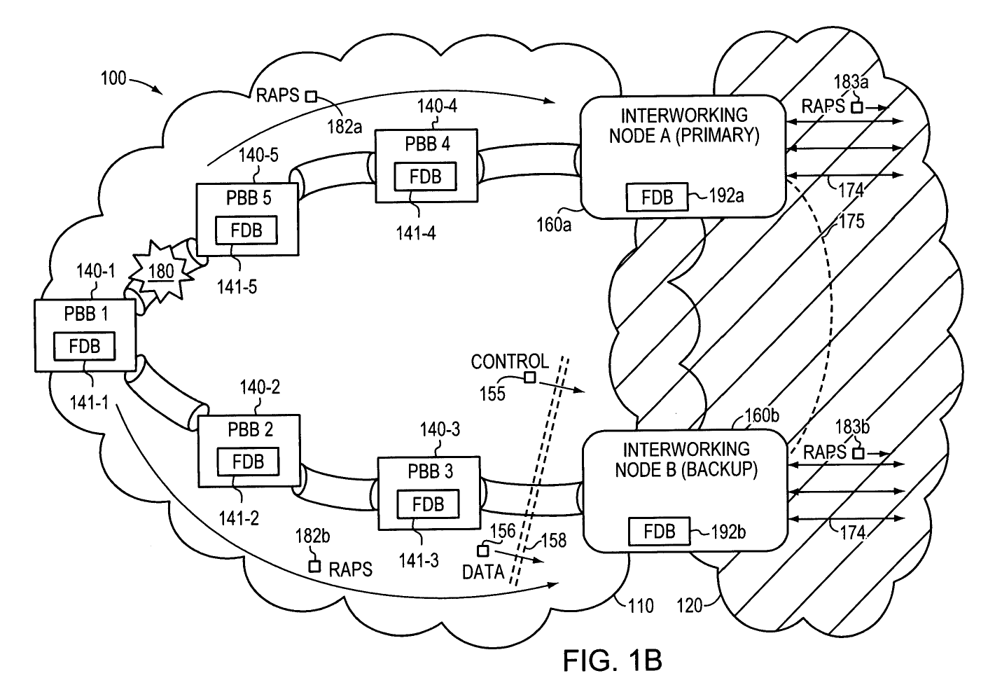

FIG. 1A is a network diagram showing a heterogeneous network 100 in an embodiment of the invention. The heterogeneous network 100 includes an access ring aggregation network 110 and a core network 120, with an interface between the two networks provided by interworking nodes 160a and 160b (generally 160a,b). The access ring aggregation network 110 has ring nodes 140-1, 140-2, 140-3, 140-4, and 140-5 (generally 140-1 . . . 5) in conformance with IEEE 802.1ah, which specifies the Provider Backbone Bridge (PBB) standard. The ring nodes 140-1 . . . 5 are said to be “ring” nodes because they employ G.8032 functionality, e.g., connectivity check messages and operations and management (OAM) for link status monitoring, although they do not form a ring by themselves, strictly speaking. It should be understood that FIG. 1A is illustrative, and different numbers of ring nodes 140 may be used. Ring nodes 140-1 through 140-5 are labeled PBB 1 through PBB 5 in FIG. 1A. The ring nodes perform switching based on customer MAC addresses for upstream bound traffic (i.e., traffic headed towards the core network 120). A user network interface (UNI) 132 at PBB 1 140-1 provides access, e.g., via Ethernet connectivity, to a customer node 130.

PBB tunnels 150a through 150f (generally 150a-f) are used as edges in the access ring aggregation network 110. The PBB tunnels 150a-f provide dual homing connectivity to the core network 120 via interworking node A 160a and interworking node B 160b, which may be configured as a primary node and a backup node, respectively. Dual homing refers to a configuration in which two access points are provided for security and reliability, thereby avoiding a single point of failure.

In a normal mode of operation, as shown in FIG. 1A, interworking node A 160a, which is designated as a primary node, provides a connection between the access ring aggregation network 110 and the core network 120. A Ring Protection Link (RPL) break 158 (as indicated by a solid line and a dashed line) is established between PBB 3 140-3 and backup interworking node B 160b. The RPL break allows a control message 155 to pass from PBB 3 140-3 to interworking node B 160b but does not allow a user (data) message 156 to pass. Such RPL breaks are available in the G.8032 protocol and are used in a conventional ring network to prevent messages from looping indefinitely. In the context of embodiments of the present invention, RPL is used to disable user traffic access to the core network 120 via backup interworking node B under normal conditions.

The RPL break 158 is shown in FIG. 1A at the PBB tunnel 150f; alternatively, other PBB tunnels along the path from PBB 1 140-1 to backup interworking node B 160b can be used for this purpose, e.g., PBB tunnels 150d or 150e in FIG. 1A can be used.

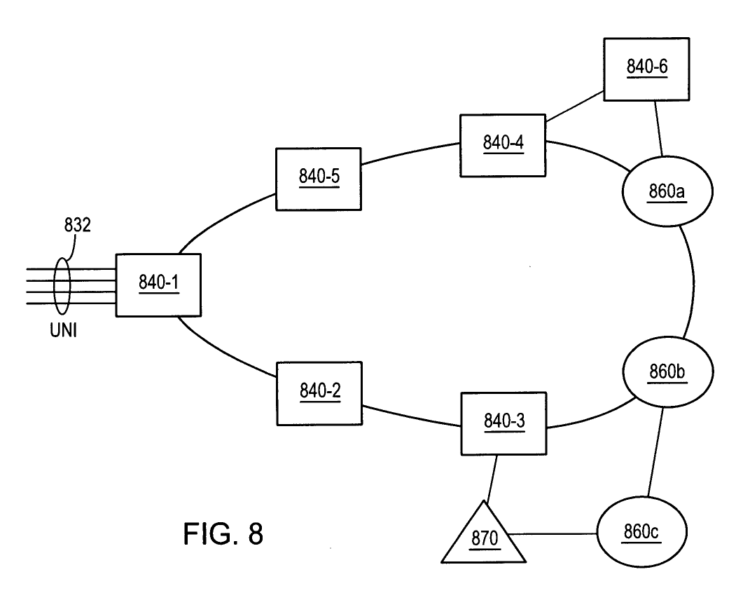

Link status messages 152a and 152b (generally 152a,b) are exchanged between PBB 4 140-4 and PBB-5 140-5, which are said to be in a peering relationship with one another. Link status messages 152a,b are also exchanged between other pairs of adjacent peer ring nodes and between the interworking nodes 160a and 160b and their respective peer nodes PBB 4 140-4 and PBB 3 140-3. Link status messages may also be exchanged between non-adjacent peer nodes, e.g., via an intermediate node that serves as a proxy, as will be described below in the context of FIG. 8. The link status messages serve as a heartbeat and may use connectivity check message (CCM) signaling according to IEEE 802.1ag. For example, if a link status message 152a,b is not received within a predetermined period of time (e.g., 10 ms), a link failure may be declared. In some cases, a specified number of missed link status messages 152a,b must transpire (i.e., a specified number of expected link status messages 152a,b must be missed) in order to declare link failure.

The interworking nodes 160a and 160b maintain connectivity with each other by exchanging connectivity status messages 176a and 176b (generally 176a,b). The connectivity status messages 176a,b may utilize a Fast Re-route (FRR) mechanism, e.g., in the case of the core network 120 being an MPLS network, to ensure connectivity within 50 ms, for example. The connectivity status messages 176a,b establish a logical connection (which may also be a physical connection) 175 between the interworking nodes 160a and 160b, i.e., the interworking nodes 160a and 160b are logically adjacent to each other. The logical connection may utilize intermediate nodes (not shown) in the core network 120. In some embodiments, CCM signaling is maintained over the logical connection 175.

The interworking nodes 160a and 160b include virtual switching instances (VSIs) 170-1a, 170-2a, 170-3a (at 160a) and 170-1b, 170-2b, 170-3b (at 160b) (VSIs generally denoted as 170-1 . . . 3a,b). For illustration, at each interworking node 160a,b, the VSIs 170-1 . . . 3a,b are labeled VSI 1, VSI 2, and VSI 3, and are shown to connect to ISID 1 162-1, ISID 2 162-2, and ISID 3 162-3, respectively (generally 162-1 . . . 3), although VSIs 170-1 . . . 3a,b need not connect to same-numbered ISIDs 162-1 . . . 3. Different numbers of VSIs 170-1 . . . 3a,b may be used at the primary and backup interworking nodes 160a and 160b, respectively. The interworking nodes 160a and 160b terminate PBB tunnels 150c and 150f, respectively, and extract instance service identifier (ISID) information (shown as 162-1 . . . 3 generally at each tunnel). At each interworking node 160a, 160b, Ethernet packets are forwarded by a VSI 170-1 . . . 3a,b to the appropriate pseudowire 174 for transport across the core network 120. Thus, ISID fields (tyically 24 bits in length) are used as service delimiters and identifiers to be associated into virtual private network (VPN) instances.

ISID information 162-1 . . . 3 identified as control messaging is routed at each interworking node 160a, 160b to a control VSI (designated as 172a, 172b, respectively; generally 172a,b), which outputs the control information on the logical connection 175 to the other interworking node. In this way, a ring network is formed using the access ring aggregation network 110 and the core network 120 to transmit control information according to G.8032. Since the interworking nodes 160a,b monitor link status with peer nodes 140-3, 140-4 in the access ring aggregation network 110, the interworking nodes 160a,b can be said to emulate functionality of the ring nodes 150. Thus, the interworking nodes 160a,b can be said to be part of both the access ring aggregation network 110 and the core network 120.

FIG. 1B shows the heterogeneous network 100 of FIG. 1A in a state of link failure. For clarity, not all the elements of FIG. 1A are repeated in FIG. 1B. FIG. 1B shows a link failure 180 between PBB 1 140-1 and PBB 5 140-5. The link failure 180 may be detected via the link status messages 152 (i.e., loss thereof) and may be between other ring nodes than PBB 1 and PBB 5. Detection of the link failure 180 initiates a failover mechanism that switches internetworking to a path between the access ring aggregation network 110 and the core network 120 that utilizes the backup interworking node B 160b. The failover mechanism provides recovery from outages and end-to-end protection typically within 1 second. The G.8032 portion of the heterogeneous network 100 converges within 50 ms by a ring steering mechanism, as is known in the art of G.8032, while the MPLS portion converges within 50 ms by the MPLS RSVP Fast Re-Route mechanism.

Upon detection of the link failure 180, a ring automatic protection switching (RAPS) message is propagated from the ring node PBB 5 140-5 towards the interworking node A 160a. Another RAPS message 182b is propagated from the ring node PBB 1 140-1 towards the interworking node B 160b. Each ring node 140-1, . . . , 140-5 has a forwarding database 141-1, . . . , 141-5 (generally 141-1 . . . 5) containing media access control (MAC) address information that is learned at Layer 2 according to the principles of bridging (switching). The RAPS messages 182a and 182b (generally 182a,b) inform each ring node 140-1 . . . 5 along the dual paths to the interworking nodes 160a,b to flush their respective forwarding databases 141 to force MAC re-learning. The interworking nodes 160a,b, upon receiving the RAPS messages 182, flush their own respective forwarding databases 192a and 192b (generally 192a,b) and propagate respective RAPS messages 183a, 183b (generally 183a,b) to other nodes in the core network 120 in order to force MAC re-learning in the core network 120. MAC flushing and convergence is typically achieved in less than one second. Flushing MAC forwarding databases helps achieve fast convergence for MAC bridging instead of waiting for an aging timer (e.g., a timeout) to expire.

Also upon detection of the link failure 180, the RPL segment 158 is cleared (unblocked, as indicated by a double dashed line in FIG. 1B) to enable the user packet 156 to pass along with the control packet 155. In this way, the backup interworking node B 160b is enabled to provide connectivity between the access ring aggregation network 110 and the core network 120. In some embodiments, when the link failure 180 is restored (repaired), the RPL segment 158 is re-blocked.

An embodiment of the invention is a method, or corresponding apparatus, of internetworking. The method includes monitoring a status of a link between an interworking node and at least one peer node in a first network that includes a first plurality of nodes at an interface between the first network and a second network. The second network includes a second plurality of nodes including the interworking node and other interworking node(s). Connectivity is maintained between the interworking node and the other interworking node(s) via the second network. The method further includes supporting communications between the first and second networks via at least one of the interworking nodes and supporting ring communications among the interworking node, the other interworking node(s), and the peer node(s).

The method may further include including supporting network traffic and operational characteristics according to G.8032 on the first network and multi-protocol label switching (MPLS) on the second network.

The method may further include enabling a user network interface (UNI) at a node among first plurality of nodes and supporting primary and backup interworking node activities by way of interworking nodes designated as a primary and a backup interworking node, respectively.

The method may further include blocking a segment between a selected interworking node and a corresponding peer node to disable user traffic flow.

The method may further include detecting a failure in the link by checking for a lost continuity check messaging (CCM) signal. Based on detecting the failure, the segment may be blocked, a media access control (MAC) forwarding database at a node in the first network may be flushed, a ring automatic protection switching (RAPS) signal may be propagated towards at least one of the interworking nodes, and switching to the backup interworking node may be performed for traffic between the first and second networks.

Another embodiment of the invention is a method of internetworking at an interworking node. The method includes monitoring a status of a link between the interworking node and at least one peer node in a first network including a first plurality of nodes at an interface between the first network and a second network. The second network includes a second plurality of nodes including the interworking node and at least one other interworking node. Connectivity is maintained between the interworking node and the other interworking node(s) via the second network. The method further includes supporting communications between the first and second networks via at least one of the interworking nodes.

The method may further include supporting network traffic and operational characteristics according to G.8032 on the first network and multi-protocol label switching (MPLS) on the second network.

The method may further include blocking a segment between the interworking node and the peer node(s) in the first network to disable user traffic flow.

The method may further include detecting a failure in the link by checking for a lost connectivity check message (CCM) signal. Based on detecting the failure, a media access control (MAC) database of the interworking node may be flushed, and a ring automatic protection switching (RAPS) message may be sent to a third node in the second network to relearn MAC addresses in the second network.

The method may further include receiving a ring automatic protection switching (RAPS) signal, flushing a media access control (MAC) database of the interworking node based on receiving the RAPS signal, and sending a ring automatic protection switching (RAPS) message to a third node in the second network based on receiving the RAPS signal to relearn MAC addresses in the second network.

In a corresponding apparatus embodiment, an interworking node has a link status module configured to monitor a status of a link between the interworking node and a peer node in a first network. The interworking node also has a connection status module configured to monitor a connectivity status between the interworking node and another interworking node. The interworking nodes are configured to support interworking activities at an interface between the first network and a second network including the interworking nodes. The interworking node further includes an internetworking information storage unit to store information to enable traffic to flow via the interworking node between the first network and the second network. The interworking node also includes a traffic support module to enable traffic to flow in a ring among the interworking node, the other interworking node, and at least the peer node in the first network.

The link status module may employ a ring protocol, the other interworking node may include a corresponding link status module, and the interworking nodes may be configured, based on their respective link status modules, to emulate functionality of a node in the first network.

Another embodiment of the invention is a method, or corresponding apparatus, that includes employing a ring protocol at multiple ring nodes and employing a second protocol different from the ring protocol at an interworking node in a plurality of interworking nodes. The method further includes monitoring a status of a link between the interworking node and a peer node among the ring nodes and a connectivity state with another interworking node. Ring communications are supported among at least the interworking node, the peer node, and the other interworking node.

The method may further include supporting network traffic and operational characteristics according to G.8032 as the ring protocol and multi-protocol label switching (MPLS) as the second protocol.

The method may further include enabling a user network interface (UNI) at a ring node and supporting primary and backup interworking node activities by way of interworking nodes designated as a primary and a backup interworking node, respectively.

The method may further include blocking a segment between a selected interworking node and a corresponding peer node to disable user traffic flow.

The method may further include detecting a failure in the link by checking for a lost continuity check messaging (CCM) signal. Based on detecting the failure, the segment may be unblocked, a media access control (MAC) forwarding database at a ring node may be flushed, a ring automatic protection switching (RAPS) signal may be propagated towards at least one of the interworking nodes, and switching to the backup interworking node may be performed for traffic between the ring network and another network employing the second protocol.

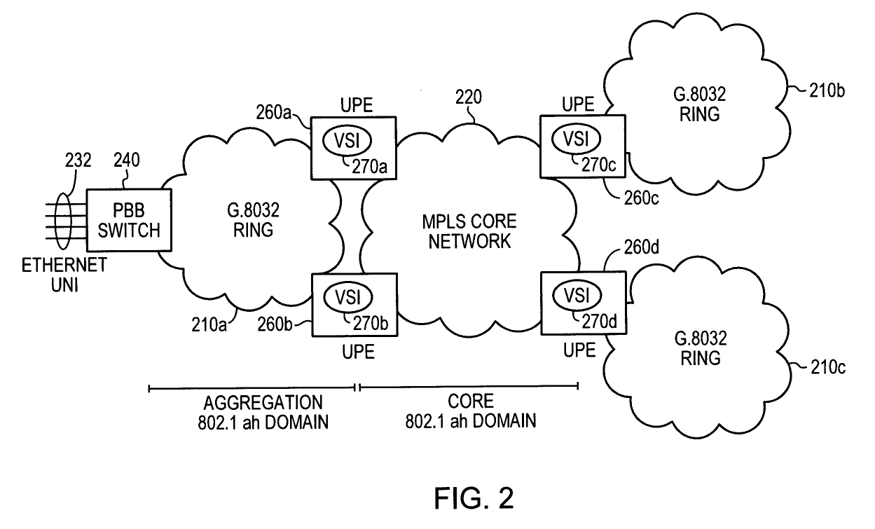

FIG. 2 is a network diagram showing an interconnection between multiple ring networks and a core network in or according to an embodiment of the invention. An Ethernet UNI 232 and a PBB switch 240 provide attachment to a G.8032 ring network 210a, which is connected via user-side provider edge (UPE) nodes 260a, 260b to an MPLS core network 220. The UPE nodes 260a and 260b may be interworking nodes as in FIGS. 1A-B. The MPLS core network 220 is connected to other G.8032 ring networks 210b, 210c via respective UPE nodes 260c, 260d. For clarity, dual homing is not shown in the connections to the G.8032 ring networks 210b, 210c, but it should be understood that dual homing may be provided there as well.

Although three G.8032 ring networks 210a-210c (generally 210a-c) are shown, it should be understood that other numbers may be present, and more than one MPLS core network 220 may be present. Each UPE node 260a-260d (generally 260a-d) has an associated VSI 270a-270d (generally 270a-d) to connect the associated G.8032 ring network 210 and the associated MPLS core network 220. Aggregation services are provided by 802.1ah in each G.8032 ring network 210. Core services are provided by 802.1ah in the MPLS core network 220.

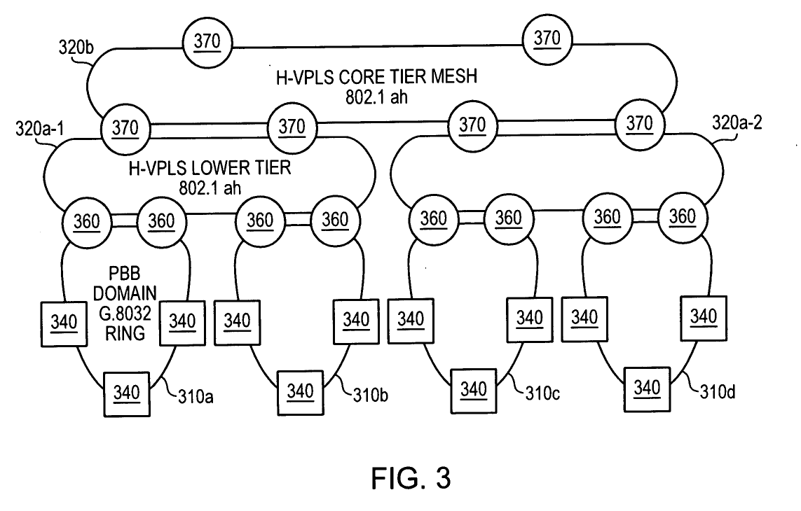

FIG. 3 is a network diagram showing an implementation of an embodiment of the invention in a hierarchical Virtual Private LAN Service (VPLS) network. Multiple ring networks 310a, 310b, 310c, and 310d (generally 310a-d) are shown; different numbers of ring networks are possible. Each ring network 310a-d forms a PBB domain and has ring nodes 340. Hierarchical VPLS is provided by lower tier networks 320a-1 and 320a-2 (generally 320a-1,2) and by a core tier mesh 320b, all employing 802.1ah (PBB). Interworking nodes 360 connect the ring networks 310a-d with the lower tier networks 320a-1,2. A dual homing configuration is employed in some embodiments, as shown in FIG. 3. VPLS nodes 370 connect the lower tier networks 320a-1,2 with the core tier mesh 320b, with a dual homing configuration possible at this stage as well.

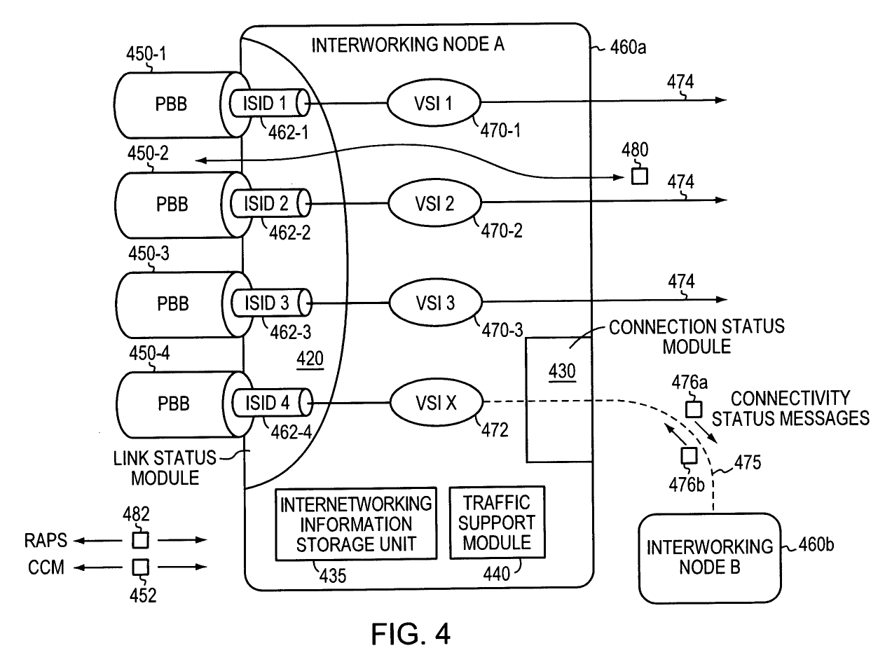

FIG. 4 is a block diagram of an interworking node in an embodiment of the invention. Interworking node A 460a communicates with PBB interfaces 450-1, 450-2, 450-3, and 450-4 (generally 450-1 . . . 4), at which ISID 1 462-1, ISID 2 462-2, ISID 3 462-3, and ISID 4 462-4 are terminated, respectively. Through the PBB interfaces 450-1 . . . 4, the interworking node A 460a communicates with peer nodes (not shown) in a first network including the peer nodes and interworking node A 460a.

A link status module 420 in interworking node A 460a monitors link status with peer nodes, e.g., using a connectivity check message (CCM) 452, over the PBB interfaces 450-1 . . . 4.

A connection status module 430 monitors connectivity status between interworking node A 460a and an interworking node B 460b. Interworking node A 460a and interworking node B 460b form an interface between the first network including the peer nodes (not shown) and a second network including the interworking nodes 460a and 460b.

An internetworking information storage unit 435 stores information to enable a message 480 to flow between the first and second networks; such traffic flow is bidirectional in some embodiments. The internetworking information storage unit 435 maps ISIDs to VSIs. Although FIG. 4 shows ISID 1 462-1 mapping to VSI 1 470-1, ISID 2 462-2 mapping to VSI 2 470-2, and ISID 3 462-3 mapping to VSI 3 470-3 for clarity, arbitrary mappings between ISIDs and VSIs are possible. The information storage unit 435 also includes a RAPS state machine (not shown), which, along with CCM, provides G.8032 control, as is known in the art of G.8032.

A traffic support module 440 enables traffic (e.g., CCMs 476a and 476b) to flow in a ring among the interworking node A 460a, the interworking node B 460b, and at least one peer node (not shown). Incoming control packets, e.g., a RAPS messages 482, are sent to a control VSI 472 (labeled VSI X in FIG. 4), which outputs control packets on the logical connection 475 to the interworking node B 460b. The interworking node A 460a uses a dedicated backbone virtual LAN ID (BVID) for control channel processing of RAPS and CCM signals.

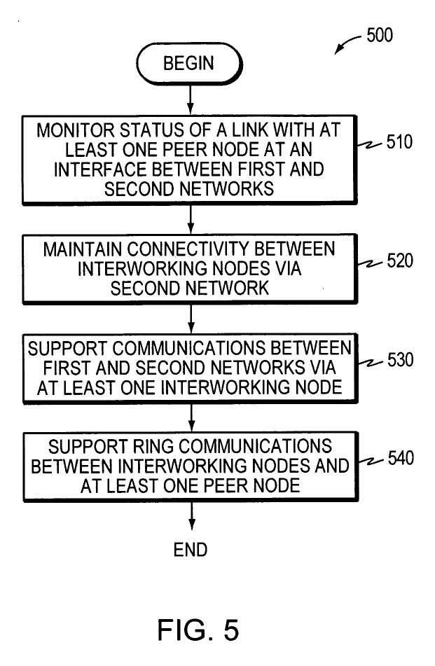

FIG. 5 is a flow diagram 500 of internetworking at an interworking node according to an embodiment of the invention. After beginning, the flow diagram includes monitoring the status of a link between the interworking node and at least one peer node in a first network at an interface between the first network and another network (510). Connectivity is maintained, via the other network, between the interworking node and another interworking node that is in the other network, which includes the interworking nodes (520). Communications are supported between the first and second networks via at least one interworking node (530). Ring communications are supported between at least two interworking nodes and at least one peer node (540). Although the flow diagram 500 is shown to transpire in a particular sequence, other sequences are possible as well in other embodiments.

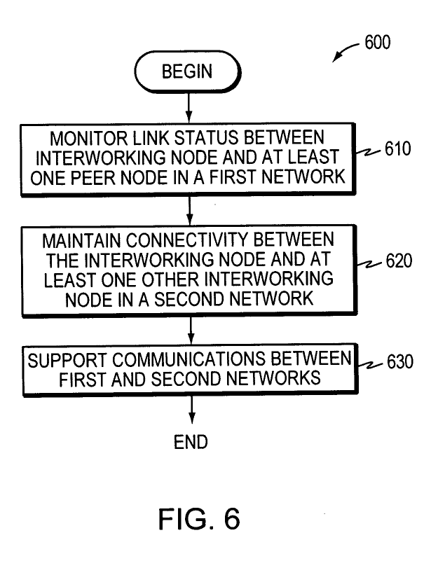

FIG. 6 is a flow diagram 600 of internetworking at an interworking node according to another embodiment of the invention. After beginning, the flow diagram includes monitoring the status of a link between the interworking node and at least one peer node in a first network at an interface between the first network and another network (610). Connectivity is maintained, via the other network, between the interworking node and another interworking node that is in the other network, which includes the interworking nodes (620). Communications are supported between the first and second networks via at least one interworking node (630). Although the flow diagram 600 is shown to transpire in a particular sequence, other sequences are possible as well in other embodiments.

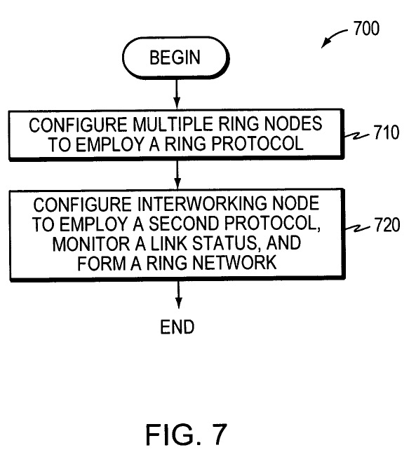

FIG. 7 is a flow diagram 700 of networking according to an embodiment of the invention. After beginning, multiple ring nodes are configured to employ a ring protocol. At least one interworking node in a plurality of interworking nodes is configured to employ a second protocol different from the ring protocol. The second protocol may be a different ring protocol or a non-ring protocol different from the ring protocol. The interworking node (or nodes) is further configured to monitor: 1) a status of a link between itself and a peer node among the ring node and a connectivity state with another interworking node. The interworking node (or nodes) is also configured to form a ring network with at least the peer node and the other interworking node. Although the flow diagram 700 is shown to transpire in a particular sequence, other sequences are possible as well in other embodiments.

While this invention has been particularly shown and described with references to example embodiments thereof, it will be understood by those skilled in the art that various changes in form and details may be made therein without departing from the scope of the invention encompassed by the appended claims.

FIG. 8 shows alternative topologies that may be employed according to embodiments of the invention. Ring nodes 840-1 through 840-6 (generally 840-1 . . . 6) may be configured to employ G.8032 and 802.1ah (PBB). A user network interface 832 is provided at at least one of the ring nodes (at 840-1 in the example of FIG. 8, but multiple UNIs could be provided). Interworking nodes 860a, 860b, and 860c (generally 860a-c) provide interworking between a first network including the ring nodes 840-1 . . . 6 and a second network including the interworking nodes 860a-c. In the example shown in FIG. 8, interworking node 860a has two peer nodes: 840-4 and 840-6. FIG. 8 shows that more than two interworking nodes 860a-c can be used, e.g., for additional backup protection. A peering relationship need not be direct; interworking node 860c has a peering relationship with ring node 840-3 by way of a proxy node 870. The proxy node may be in a separate network from the ring nodes 840 and the interworking nodes 860a-c (i.e., employing a different protocol and/or functionality).

Embodiments or aspects of the invention may be implemented in hardware, firmware, or software, if implemented in software, the software may be implemented in any software language capable of performing the embodiment(s) of the invention. The software may be stored on any computer-readable medium, such as RAM, ROM, CD-ROM, and so forth. The software includes instructions that can be loaded and executed by a general purpose or application specific processor capable of supporting embodiment(s) of the invention.

What is claimed is:

1. A heterogeneous network comprising:
a first network including a first plurality of nodes;
a second network including a second plurality of nodes, the second plurality of nodes including multiple interworking nodes at an interface between the first network and the second network, each interworking node configured to monitor a status of a link between itself and at least one peer node on the first network and maintain connectivity with another interworking node via the second network, at least a subset of the first plurality of nodes and the multiple interworking nodes forming a ring with a configuration in which at least two of the multiple interworking nodes are logically adjacent to each other.

2. The heterogeneous network of claim 1, wherein the first network is an access ring aggregation network employing G.8032 and the second network is a core network employing multi-protocol label switching (MPLS).

3. The heterogeneous network of claim 1, further including a user network interface (UNI) at a node of the first plurality of nodes, and wherein the heterogeneous network includes at least two interworking nodes on the first network, each communicating with a corresponding peer node, two of the at least two interworking nodes configured as a primary and a backup interworking node, respectively.

4. The heterogeneous network of claim 3, further including a segment between one of the interworking nodes and a corresponding peer node, the segment configured to be blocked to disable user traffic flow.

5. The heterogeneous network of claim 1, further including a link failure module configured to detect a failure in the link based on lost connectivity check message (CCM) signaling and initiate a failover mechanism to cause the multiple interworking nodes to:
switch internetworking between the first and second networks to a path including the backup interworking node;
flush a media access control (MAC) forwarding database at each interworking node;
receive a ring automatic protection switching (RAPS) signal; and
propagate the RAPS signal to a node in the second network to relearn MAC addresses in the second network.

6. A method of internetworking, the method comprising:
monitoring a status of a link between an interworking node and at least one peer node in a first network, including a first plurality of nodes, at an interface between the first network and a second network, the second network including a second plurality of nodes including the interworking node and at least one other interworking node;
maintaining connectivity between the interworking node and the at least one other interworking node via the second network;
supporting communications between the first and second networks via at least one of the interworking nodes; and
supporting ring communications among the interworking node, the at least one other interworking node, and the at least one peer node.

7. The method of claim 6, further including supporting network traffic and operational characteristics according to G.8032 on the first network and multi-protocol label switching (MPLS) on the second network.

8. The method of claim 7, further including:
enabling a user network interface (UNI) at a node of the first plurality of nodes; and
supporting primary and backup interworking node activities by way of interworking nodes designated as a primary and a backup interworking node, respectively.

9. The method of claim 8, further including blocking a segment between a selected interworking node and a corresponding peer node to disable user traffic flow.

10. The method of claim 9, further including:
detecting a failure in the link by checking for a lost continuity check messaging (CCM) signal;
based on detecting the failure:
unblocking the segment,
flushing a media access control (MAC) forwarding database at a node in the first network,
propagating a ring automatic protection switching (RAPS) signal towards at least one of the interworking nodes, and
switching to the backup interworking node for traffic between the first and second networks; and
based on receiving the RAPS signal at an interworking node:
flushing a MAC forwarding database of the interworking node that received the RAPS signal, and
forwarding the RAPS signal to at least one of the second plurality of nodes to relearn MAC addresses in the second network.

11. An interworking node comprising:
a link status module configured to monitor a status of a link between the interworking node and a peer node in a first network;
a connection status module configured to monitor a connectivity status between the interworking node and another interworking node, the interworking nodes configured to support interworking activities at an interface between the first network and a second network including the interworking nodes;
an internetworking information storage unit to store information to enable traffic to flow via the interworking node between the first network and the second network; and
a traffic support module to enable traffic to flow in a ring among the interworking node, the other interworking node, and at least the peer node in the first network.

12. The interworking node of claim 11, wherein the link status module employs a ring protocol, the other interworking node includes a corresponding link status module, and the interworking node and the other interworking node are each configured, based on their respective link status modules, to emulate functionality of a node in the first network.

13. The interworking node of claim 11, further including a blocking module configured to block traffic across a segment between the interworking node and the peer node in order to disable flow of user traffic.

14. The interworking node of claim 11, wherein the link status module includes a continuity check message (CCM) module configured to:
detect a lost CCM signal on a control channel of the interworking node;
flush a media access control (MAC) database of the interworking node based on the lost CCM signal; and
send a ring automatic protection switching (RAPS) message to a third node in the second network based on the lost CCM signal to relearn MAC addresses in the second network.

15. The first network node of claim 11, further including a ring automatic protection switching (RAPS) module configured to:
flush a media access control (MAC) database of the interworking node based on receiving a RAPS signal on a control channel of the interworking node; and
send a RAPS message to a third node in the first network based on the received RAPS signal to relearn MAC addresses in the first network.

16. A method of internetworking at an interworking node, the method comprising:
monitoring a status of a link between the interworking node and at least one peer node in a first network, including a first plurality of nodes, at an interface between the first network and a second network, the second network including a second plurality of nodes including the interworking node and at least one other interworking node;
maintaining connectivity between the interworking node and the at least one other interworking node via the second network; and
supporting communications between the first and second networks via at least one of the interworking nodes.

17. The method of claim 16, further including supporting network traffic and operational characteristics according to G.8032 on the first network and multi-protocol label switching (MPLS) on the second network.

18. The method of claim 16, further including blocking a segment between the interworking node and the at least one peer node in the first network to disable user traffic flow.

19. The method of claim 16, further including:
detecting a failure in the link by checking for a lost connectivity check message (CCM) signal; and
based on detecting the failure:
flushing a media access control (MAC) database of the interworking node, and
sending a ring automatic protection switching (RAPS) message to a third node in the second network to relearn MAC addresses in the second network.

20. The method of claim 16, further including:
receiving a ring automatic protection switching (RAPS) signal;
flushing a media access control (MAC) database of the interworking node based on receiving the RAPS signal; and
sending a ring automatic protection switching (RAPS) message to a third node in the second network based on receiving the RAPS signal to relearn MAC addresses in the second network.

21. A ring network comprising:
multiple ring nodes employing a ring protocol; and
multiple interworking nodes, each interworking node employing at least a second protocol different from the ring protocol and configured to monitor a status of a link between itself and a ring node and maintain connectivity with another interworking node.

22. The ring network of claim 21, wherein the first network is an access ring aggregation network employing G.8032 and the second network is a core network employing multi-protocol label switching (MPLS).

23. The ring network of claim 21, further including:
a user network interface (UNI) at a ring node, and
wherein the ring network includes at least two interworking nodes, each communicating with a respective peer node employing the ring protocol, two of the at least two interworking nodes configured as a primary and a backup interworking node, respectively.

24. The ring network of claim 23, further including a segment between a selected interworking node and a corresponding peer node, the segment configured to be blocked to disable user traffic flow.

25. The ring network of claim 24, further including a link failure module configured to:
detect a failure in the link based on a lost connectivity check message (CCM);
switch internetworking between the first and second networks to a path including the backup interworking node based on the failure;
flush a media access control (MAC) forwarding database; and
propagate a ring automatic protection switching (RAPS) signal towards at least one of the interworking nodes.

26. A method of networking comprising:
employing a ring protocol at multiple ring nodes;
employing a second protocol different from the ring protocol at an interworking node in a plurality of interworking nodes;
monitoring a status of a link between the interworking node and a peer node among the ring nodes and a connectivity state with another interworking node, and supporting ring communications among at least the interworking node, the peer node, and the other interworking node.

27. The method of claim 26, further including supporting network traffic and operational characteristics according to G.8032 as the ring protocol and multi-protocol label switching (MPLS) as the second protocol.

28. The method of claim 26, further including:
enabling a user network interface (UNI) at a ring node; and
supporting primary and backup interworking node activities by way of interworking nodes designated as a primary and a backup interworking node, respectively.

29. The method of claim 28, further including blocking a segment between a selected interworking node and a corresponding peer node to disable user traffic flow.

30. The method of claim 29, further including:
detecting a failure in the link by checking for a lost continuity check messaging (CCM) signal;
based on detecting the failure:
unblocking the segment,
flushing a media access control (MAC) forwarding database at a ring node,
propagating a ring automatic protection switching (RAPS) signal towards at least one of the interworking nodes, and
switching to the backup interworking node for traffic between the ring network and another network employing the second protocol; and
based on receiving the RAPS signal at an interworking node:
flushing a MAC forwarding database of the interworking node that received the RAPS signal, and
forwarding the RAPS signal to a node in the other network to relearn MAC addresses in the other network.
